(19) United States
(12) Patent Application Publication
(10) Pub. No.: US 2005/0259006 A1
(43) Pub. Date: Nov. 24, 2005

(54) Beam forming apparatus and method using interference power estimation in an array antenna system

(75) Inventors: Byoung-Yun Kim, Suwon-si (KR); Song-Hun Kim, Suwon-si (KR); Hyeon-Woo Lee, Suwon-si (KR); Kwang-Yung Jeong, Yongin-si (KR); Hye-Young Lee, Seoul (KR); Peter Jung, Duisburg (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/135,631

(22) Filed: May 24, 2005

(30) Foreign Application Priority Data
May 24, 2004 (KR) 2004-36746

(51) Int. Cl. H04B 1/00; H01Q 3/00; G01S 3/16

(52) U.S. Cl. 342/377; 455/509; 455/63.4

(57) ABSTRACT

An apparatus and method are provided for simply estimating joint channel and Direction-of-Arrival (DOA) to efficiently estimate a channel impulse response associated with a spatially selective transmission channel occurring in a mobile radio channel, and performing efficient beam forming using the simplified joint channel and DOA estimation are provided. A receiver estimates the total interference power using power for each interference signal, estimates a spectral noise density, calculates steering vectors considering predetermined DOAs, and jointly calculates optimal weight vectors for each DOA of each user by applying the interference power and the spectral noise density to the steering vectors. The beam forming reduces implementation complexity of a TDD system such as a TD-SCDMA and increases beam forming efficiency in a mobile environment by efficiently using spatial diversity.

### PRIORITY

This application claims the benefit under 35 U.S.C. § 119(a) of an application entitled “Beam Forming Apparatus and Method Using Interference Power Estimation in an Array Antenna System” filed in the Korean Intellectual Property Office on May 24, 2004 and assigned Serial No. 2004-36746, the entire contents of which are incorporated herein by reference.

### BACKGROUND OF THE INVENTION

1. Field of the Invention

The present invention relates generally to an array antenna system, and in particular, to an apparatus and method for optimal beam forming for transmitting and receiving high-speed data at high performance.

2. Description of the Related Art

Reception quality of radio signals is affected by many natural phenomena. One of the natural phenomena is temporal dispersion caused by signals reflected on obstacles in different positions in a propagation path before the signals arrive at a receiver. With the introduction of digital coding in a wireless system, a temporal dispersion signal can be successfully restored using a Rake receiver or equalizer.

Another phenomenon called fast fading or Rayleigh fading is spatial dispersion caused by signals which are dispersed in a propagation path by an object located a short distance from a transmitter or a receiver. If signals received through different spaces, i.e., spatial signals, are combined in an inappropriate phase region, the sum of the received signals is very low in intensity, approaching zero. This becomes a cause of fading dips where received signals substantially disappear, and the fading dip occurs as frequently as a length corresponding to a wavelength.

A known method of removing fading is to provide an antenna diversity system to a receiver. The antenna diversity system includes two or more spatially separated reception antennas. Signals received by the respective antennas have low relation in fading, reducing the possibility that the two antennas will simultaneously generate the fading dips.

Another phenomenon that significantly affects radio transmission is interference. Interference is defined as an undesired signal received on a desired signal channel. In a cellular radio system, interference is directly related to a requirement of communication capacity. Because radio spectrum is a limited resource, a radio frequency band given to a cellular operator should be efficiently used.

Due to increasing use of cellular systems and their deployment over increasing numbers of geographic locations, research is being conducted on an array antenna geometry connected to a beam former (BF) as a new scheme for increasing traffic capacity by removing any influences of interference and fading. Each antenna element forms a set of antenna beams. A signal transmitted from a transmitter is received by each of the antenna beams, and spatial signals experiencing different spatial channels are maintained by individual angular information. The angular information is determined according to a phase difference between different signals. Direction estimation of a signal source is achieved by demodulating a received signal. A direction of a signal source is also called a “Direction of Arrival (DOA).”

Estimation of DOAs is used to select an antenna beam for signal transmission to a desired direction or to steer an antenna beam in a direction where a desired signal is received. A beam former estimates steering vectors and DOAs for simultaneously detected multiple spatial signals, and determines beam-forming weight vectors from a set of the steering vectors. The beam-forming weight vectors are used for restoring signals. Algorithms used for beam forming include Multiple Signal Classification (MUSIC), Estimation of Signal Parameters via Rotational Invariance Techniques (ESPRIT), Weighted Subspace Fitting (WSF), and Method of Direction Estimation (MODE).

An adaptive beam forming process depends on precise knowledge of the spatial channels. Therefore, adaptive beam forming can generally only be accomplished after estimation of the spatial channels. This estimation should consider not only temporal dispersion of channels, but also DOAs of radio waves received at a reception antenna.

In an antenna diversity system using an array antenna, resolvable beams are associated with DOAs of max(N_{b}) maximum incident waves. In order to achieve beam forming, a receiver should acquire information on DOAs, and the acquisition of DOA information can be achieved through DOA estimation. However, estimated DOAs are not regularly spaced apart from each other. Therefore, in a digital receiver, conventional beam forming includes irregular spatial samplings. The ultimate goal of beam forming is to separate an incident wave (or impinging wave) so as to fully use spatial diversity in order to suppress fading. However, its latent faculty is limited by the geometry of an array antenna having a finite spatial resolution.

When a multipath, multiuser scenario is used, the conventional beam forming method cannot be used any longer because it assumes a single-path channel. Spatial selective channel estimation based on irregular spatial sampling proposed to solve this problem requires considerably complex implementation and cannot provide the advantage of the spatial diversity.

### SUMMARY OF THE INVENTION

It is, therefore, an object of the present invention to implement simplified analog and digital front ends of a radio communication system by calculating a linear system model using regular spatial samplings.

It is another object of the present invention to provide a beam forming apparatus and method in a mobile radio channel for transmitting transmission data at a possible minimum bit error rate (BER) or with possible maximum throughput.

It is further another object of the present invention to provide a beam forming apparatus and method capable of reducing implementation complexity and efficiently using spatial diversity in a Time Domain Duplex (TDD) system such as a Time Division Synchronous Code Division Multiple Access (TD-SCDMA).

It is still another object of the present invention to provide a joint least square beam forming apparatus and method using regular spatial sampling.

According to one aspect of the present invention, there is provided a beam forming apparatus for an antenna diversity system that services a plurality of users with an array antenna having a plurality of antenna elements. The apparatus comprises an interference and noise calculator for estimating interference power and spectral noise density for a radio channel from a transmitter to a receiver; and a beam former for calculating steering vectors corresponding to a predetermined number of regularly spaced predetermined direction-of-arrival (DOA) values, and calculating weight vectors for beam forming by applying the interference power and the spectral noise density to the steering vectors.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates an example of a base station with an array antenna, which communicates with a plurality of mobile stations;

FIG. 2 is a polar plot illustrating spatial characteristics of beam forming for selecting a signal from one user;

FIG. 3 is a block diagram illustrating a structure of a receiver in an array antenna system according to an embodiment of the present invention; and

FIG. 4 is a flowchart illustrating a beam forming operation according to an embodiment of the present invention.

Throughout the drawings, like reference numerals will be understood to refer to like parts, components and structures.

### DETAILED DESCRIPTION OF EXEMPLARY EMBODIMENTS

Preferred embodiments of the present invention will now be described in detail with reference to the accompanying drawings. In the following description, a detailed description of known functions and configurations incorporated herein has been omitted for conciseness.

The present invention described below does not consider DOAs of maximum incident waves that need irregular spatial sampling, in performing beam forming by estimating spatial channels in an antenna diversity system. The irregular spatial sampling requires accurate time measurement and time-varying reconstruction filtering, and is more complex to implement than a regular sampling strategy. Therefore, the present invention pre-calculates a linear system model beginning at regular spatial sampling that uses regular spatial separation for a beam angle, thereby dramatically reducing the complexity of channel estimation.

For estimation of spatial channels, a reception side requires the arrangement of an array antenna having Kₐ antenna elements. Such an array antenna serves as a spatial low-pass filter having a finite spatial resolution. The term “spatial low-pass filtering” refers to an operation of dividing an incident wave (or impinging wave) of an array antenna into spatial signals that pass through different spatial regions. A receiver having the foregoing array antenna combines a finite number, N_{b}, of spatial signals, through beam forming. As described above, the best possible beam forming requires information on DOAs and a temporal dispersion channel's impulse response for the DOAs. A value of the N_{b} cannot be greater than a value of the Kₐ, and thus represents the number of resolvable spatial signals. The maximum value, max(N_{b}), of the N_{b} is fixed according to a geometry of the array antenna.

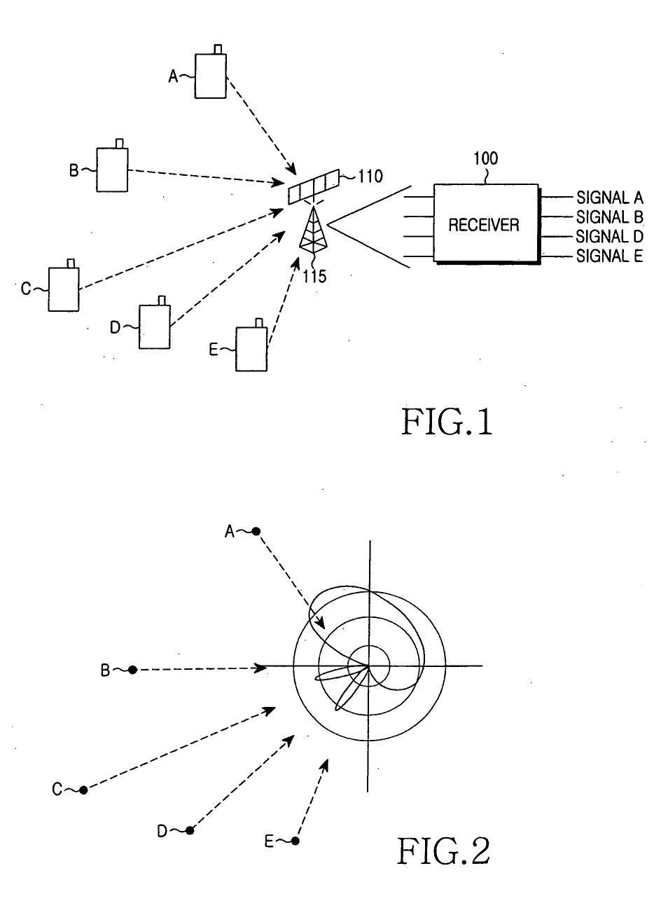

FIG. 1 illustrates an example of a base station (or a Node B) with an array antenna, which communicates with a plurality of mobile stations (or user equipments). Referring to FIG. 1, a base station 115 has an array antenna 110 comprised of 4 antenna elements. The base station 115 has 5 users A, B, C, D and E located in its coverage. A receiver 100 selects signals from desired users from among the 5 users, by beam forming. Because the array antenna 110 of FIG. 1 has only 4 antenna elements, the receiver 100 restores signals from a maximum of 4 users, e.g., signals from users A, B, D and E as illustrated, by beam forming.

FIG. 2 illustrates spatial characteristics of beam forming for selecting a signal from a user A, by way of example. As illustrated, a very high weight, or gain, is applied to a signal from a user A, while a gain approximating zero is applied to signals from the other users.

A system model applied to the present invention will first be described.

A burst transmission frame of a radio communication system has bursts including two data carrying parts (also known as sub-frames) each comprised of N data symbols. Mid-ambles which are training sequences predefined between a transmitter and a receiver, and having Lₘ chips are included in each data carrying part so that channel characteristics and interferences in a radio section can be measured. The radio communication system supports multiple access based on Transmit Diversity Code Division Multiple Access (TD-CDMA), and spreads each data symbol using a Q-chip Orthogonal Variable Spreading Factor (OVSF) code which is a user-specific CDMA code. In a radio environment, there are K users per cell and frequency band, and per time slot. As a whole, there are Kᵢ inter-cell interferences.

A base station (or a Node B) uses an array antenna having Kₐ antenna elements. Assuming that a signal transmitted by a k^{th} user (k=1, . . . , K) is incident upon (impinges on) the array antenna in k_{d}^{(d)} different directions, each of the directions is represented by a cardinal identifier k_{d} (k_{d}=1, . . . , K_{d}^{(d)}). Then, a phase factor of a k_{d}^{th} spatial signal which is incident upon the array antenna from a k^{th} user (i.e., a user #k) through a kₐ^{th} antenna element (i.e., an antenna element kₐ (kₐ=1, . . . , Kₐ)) is defined as

$$Ψ ( k , {k}_{a} , {k}_{d} ) = 2 π \frac{{l}^{( {k}_{a} )}}{λ} \cdot cos ( {β}^{( k , {k}_{d} )} - {α}^{( {k}_{a} )} ) , k = 1 ⋯ K , {k}_{a} = 1 ⋯ {K}_{a} , {k}_{d} = 1 ⋯ {K}_{d}^{( k )} \qquad ( 1 )$$

In Equation (1), α^{(k}^{_{α}}⁾ denotes an angle between a virtual line connecting antenna elements arranged with a predetermined distance from each other to a predetermined antenna array reference point and a predetermined reference line passing through the antenna array reference point, and its value is previously known to a receiver according to a geometry of the array antenna. In addition, β^{(k,k}^{_{d}}⁾ denotes a DOA in radians, representing a direction of a k_{d}^{th} spatial signal arriving from a user #k on the basis of the reference line, λ denotes a wavelength of a carrier frequency, and l^{(k}^{_{α}}⁾ denotes a distance between a kₐ^{th} antenna element and the antenna array reference point.

For each DOA β^{(k,k}_{d}⁾ of a desired signal associated with a user #k, a unique channel impulse response observable by a virtual unidirectional antenna located in the reference point is expressed by a directional channel impulse response vector of Equation (2) below representing W path channels.

$${\underline{h}}_{d}^{( k , {k}_{d} )} = {( {\underline{h}}_{d , 1}^{( k , {k}_{d} )} , {\underline{h}}_{d , 2}^{( k , {k}_{d} )} , ⋯ , {\underline{h}}_{d , W}^{( k , {k}_{d} )} )}^{T} , k = 1 ⋯ {K}_{,} {k}_{d} = 1 ⋯ {K}_{d}^{( k )} \qquad ( 2 )$$

where a superscript ‘T’ denotes transpose of a matrix or a vector, and an underline indicates a matrix or a vector.

For each antenna element kₐ, W path channels associated with each of a total of K users are measured. Using Equation (1) and Equation (2), it is possible to calculate a discrete-time channel impulse response vector representative of a channel characteristic for an antenna kₐ for a user #k as shown in Equation (3).

$${\underline{h}}^{( k , {k}_{a} )} = {( {\underline{h}}_{1}^{( k , {k}_{a} )} , {\underline{h}}_{2}^{( k , {k}_{a} )} , ⋯ , {\underline{h}}_{W}^{( k , {k}_{a} )} )}^{T} = {\sum }_{{k}_{d} = 1}^{{K}_{d}^{k}} exp \{ jΨ ( k , {k}_{a} , {k}_{d} ) \} \cdot {\underline{h}}_{d}^{( k , {k}_{d} )} , k = 1 ⋯ K , {k}_{a} = 1 ⋯ {K}_{a} \qquad ( 3 )$$

In Equation (3), h^{(k,k}^{_{d}}⁾ denotes a vector representing a discrete-time channel impulse response characteristic for a k_{d}^{th} spatial direction, from a user #k. Herein, the vector indicates that the channel impulse response characteristic includes directional channel impulse response characteristics h₁^{(k,k}^{_{d}}⁾, h₂^{(k,k}^{_{d}}⁾, . . . , h_{w}^{(k,k}^{_{d}}⁾ for W spatial channels. The directional channel impulse response characteristics are associated with the DOAs illustrated in Equation (1).

Using a directional channel impulse response vector of Equation (5) below that uses a W×(W·K_{d}^{(k)}) phase matrix illustrated in Equation (4) below including a phase factor Ψ associated with a user #k and an antenna element kₐ and includes all directional impulse response vectors associated with the user #k, Equation (3) is rewritten as Equation (6).
Aₛ^{(k,k}^{_{α}}⁾=(e^{jΨ(k,k}^{_{α}}^{,1)}I_{w}, e^{jΨ(k,k}^{_{α}}^{,2)}I_{w}, . . . ,e^{jΨ(k,k}^{_{α}}^{K}^{_{d}}^{^{(k)}}⁾I_{w}),k=1 . . . K,k_{α}=1 . . . K_{α} (4)
where Aₛ^{(k,k}^{_{α}}⁾ denotes a phase vector for K_{d}^{(d)} directions of a user #k, and I_{w} denotes a W×W identity matrix.
h_{d}^{(k)}=(h_{d}^{k,1)T},h_{d}^{(k,2)T}, . . . ,h_{d}^{k,k}^{_{d}}^{^{(k)}}^{)T})^{T},k=1 . . . K (5)
h^{(k,k}^{_{α}}⁾=A^{(k,k}^{_{α}}⁾,h_{d}^{(k)}, k=1 . . . K,k_{α}=1 . . . K_{α} (6)

Using a channel impulse response of Equation (6) associated with a user #k, a channel impulse response vector comprised of K·W elements for an antenna element kₐ for all of K users is written as

$${\underline{h}}^{( {k}_{a} )} = {( {( {\underline{A}}_{s}^{( 1 , {k}_{a} )} {\underline{h}}_{d}^{( 1 )} )}^{T} , {( {\underline{A}}_{s}^{( 2 , {k}_{a} )} {\underline{h}}_{d}^{( 2 )} )}^{T} , ⋯ , {( {\underline{A}}_{s}^{( K , {k}_{a} )} {\underline{h}}_{d}^{( K )} )}^{T} )}^{T} , {k}_{a} = 1 ⋯ {K}_{a} \qquad ( 7 )$$

A directional channel impulse response vector having K·W·K_{d}^{(k)} elements is defined as

$${\underline{h}}_{d} = {( {\underline{h}}_{d}^{( 1 ) T} , {\underline{h}}_{d}^{( 2 ) T} , ⋯ , {\underline{h}}_{d}^{( K ) T} )}^{T} \qquad ( 8 )$$

where h_{d}^{(k)} denotes a directional channel impulse response vector for a user #k.

Equation (9) below expresses a phase matrix Aₛ^{(k}^{_{α}}⁾ for all of K users for an antenna element kₐ as a set of phase matrixes for each user.

$${\underline{A}}_{s}^{( {k}_{a} )} = [ \begin{matrix}{\underline{A}}_{s}^{( 1 , {k}_{a} )} & 0 & ⋯ & 0 \\ 0 & {\underline{A}}_{s}^{( 2 , {k}_{a} )} & ⋯ & 0 \\ ⋮ & ⋮ & ⋰ & ⋮ \\ 0 & 0 & ⋯ & {\underline{A}}_{s}^{( K , {k}_{a} )}\end{matrix} ] , {k}_{a} = 1 ⋯ {K}_{a} \qquad ( 9 )$$

In Equation (9), ‘0’ denotes a W×(W·K_{d}^{(k)}) all-zero matrix, and the phase matrix Aₛ^{(k}^{_{α}}⁾ has a size of (K·W)×(K·W·K_{d}^{(k)}). Then, for Equation (7), a channel impulse response vector for all of K_{d}^{(k)} signals for all of K users at an antenna element kₐ can be calculated by
h^{(k}^{_{α}}⁾=Aₛ^{(k}^{_{α}}⁾h_{d},k_{α}=1 . . . K_{α} (10)

Using Equation (10), a combined channel impulse response vector having K·W·Kₐ elements is written as

$$\underline{h} = {( {\underline{h}}^{( 1 ) T} , {\underline{h}}^{( 2 ) T} , ⋯ , {\underline{h}}^{{( {K}_{a} )}^{T}} )}^{T} \qquad ( 11 )$$

That is, a phase matrix Aₛ in which all of K_{d}^{(k)} spatial signals for all of K users for all of Kₐ antenna elements are taken into consideration is defined as Equation (12), and a combined channel impulse response vector h is calculated by a phase matrix and a directional channel impulse response vector as shown in Equation (13).
Aₛ=Aₛ^{(1)T},Aₛ^{(2)T}, . . . ,Aₛ^{(k}^{_{α}}^{)T})^{T} (12)
h=Aₛh_{d} (13)

The matrix Aₛ, as described above, is calculated using β^{(k,k}^{_{d}}⁾ representative of DOAs for the spatial signals for each user.

Among multiple calculation processes performed to acquire a designed signal through beam forming, DOA estimation has the larger proportion. The receiver evaluates signal characteristics for all directions of 0 to 360° each time, and regards a direction having a peak value as a DOA. Because this process requires so many calculations, research is being performed on several schemes for simplifying the DOA estimation. However, even though the receiver achieves correct DOA estimation, it is actually impossible to form a beam that correctly receives only the incident wave for a corresponding DOA according to the estimated DOA. Further, in order to accurately estimate DOAs, so many calculations which are actually impossible are required.

Therefore, an embodiment of the present invention replaces the irregular spatial sampling with a regular sampling technique and uses several predetermined fixed values instead of estimating DOAs in a beam forming process.

An array antenna that forms beams in several directions represented by DOAs can be construed as a spatial low-pass filter that passes only the signals of a corresponding direction. The minimum spatial sampling frequency is given by the maximum spatial bandwidth B of a beam former. For a single unidirectional antenna, B=1/(2π).

If a spatially periodic low-pass filtering characteristic is taken into consideration using given DOAs, regular spatial sampling with a finite number of spatial samples is possible. Essentially, the number of DOAs, representing the number of spatial samples, i.e., the number of resolvable beams, is given by a fixed value N_{b}. Selection of the N_{b} depends upon the array geometry. In the case of a Uniform Circular Array (UCA) antenna where antenna elements are arranged on a circular basis, the N_{b} is selected such that it should be equal to the number of antenna elements. In the case of another array geometry, i.e., Uniform Linear Array (ULA), the N_{b} is determined by Equation (14) so that the possible maximum spatial bandwidth determined for all possible scenarios can be taken into consideration.
N_{b}=┌2πB┐ (14)

In Equation (14), ‘┌·┐’ denotes the maximum integer not exceeding a value “·”. For example, assuming that the possible maximum spatial bandwidth is B=12/(2π), there are N_{b}=12 beams.

In the case where the number of directions, K_{d}^{(k)} (k=1, . . . , K), is fixed and the regular spatial sampling is implemented according to the present invention, the number K_{d}^{(k)} of directions is equal to the number N_{b} of DOAs. Accordingly, in the receiver, a wave transmitted by a user #k affects the antenna array in the N_{b} different directions. As described above, each direction is represented by the cardinal identifier k_{d} (k_{d}=1, . . . , N_{b}), and angles β^{(k,k}^{_{d}}⁾ associated with DOAs are taken from a finite set defined as

$$B = \{ {β}_{0} , {β}_{0} + \frac{2 π}{{N}_{b}} , {β}_{0} + 2 \frac{2 π}{{N}_{b}} , ⋯ , {β}_{0} + ( {N}_{b} - 1 ) \frac{2 π}{{N}_{b}} \} \qquad ( 15 )$$

In Equation (15), βₒ denotes a randomly-selected fixed zero phase angle, and is preferably set to a value between 0 and π/N_{b} [radian]. In the foregoing example where N_{b}=12 beams and βₒ32 0 are used, Equation (15) calculates Equation (16) below corresponding to a set of angles including 0°, 30°, 60°, . . . , 330°.

$$B = \{ 0 , \frac{π}{6} , 2 \frac{π}{6} , ⋯ , 11 \frac{π}{6} \} \qquad ( 16 )$$

When the set B of Equation (15) is selected, the possible different values of β^{(k,k}^{_{d}}⁾ are the same for all users k=1, . . . , K. The values are previously known to the receiver. Therefore, the receiver no longer requires the DOA estimation.

Assuming that there are Kᵢ=N_{b} interferences, implementation of angle domain sampling will be described below. Because all the possible values of Equation (15) are acquired by angles β^{(k,k}^{_{d}}⁾ of incident values and angles γ^{(k}^{ᵢ}⁾ of interference signals, the β^{(k,k}^{_{d}}⁾ and γ^{(k}^{ᵢ}⁾ are selected by Equation (17) and Equation (18), respectively.
β^{(k,k}^{_{d}}⁾=β^{(k}^{_{d}}⁾=β₀+2π/N_{b}(k_{d}−1), k=1. . . K, k_{d}=1. . . N_{b} (17)
γ^{(k}^{ᵢ}⁾=β₀=2π/N_{b}(kᵢ−1), kᵢ=1 . . . N_{b} (18)

From the β^{(k,k}^{_{d}}⁾ and γ^{(k}^{ᵢ}⁾, a phase factor of a k_{d}^{th} spatial signal which is incident upon a kₐ^{th} antenna element (kₐ=1, . . . , Kₐ) from a k^{th} user, and a phase factor of a kᵢ^{th} interference signal which is incident upon the kₐ^{th} antenna element are calculated by Equation (19).

$$\begin{matrix}\begin{matrix}Ψ ( k , {k}_{a} , {k}_{d} ) = Ψ ( {k}_{a} , {k}_{d} ) = 2 π \frac{{l}^{( {k}_{a} )}}{λ} \cdot cos ( {β}^{( {k}_{d} )} - {α}^{( {k}_{a} )} ) , \\ Φ ( {k}_{i} , {k}_{a} ) = Φ ( {k}_{d} , {k}_{a} ) = 2 π \frac{{l}^{( {k}_{a} )}}{λ} \cdot cos ( {γ}^{( {k}_{d} )} - {α}^{( {k}_{a} )} ) ,\end{matrix} \\ {k}_{i} = {k}_{d} = 1 ⋯ {N}_{b} , {k}_{a} = 1 ⋯ {K}_{a} , k = 1 ⋯ K\end{matrix} \qquad ( 19 )$$

Herein, an angle α^{(k}^{_{α}}⁾ and a distance l^{(k}^{_{α}}⁾ are fixed by the geometry of the array antenna.

The number of columns in the phase vector Aₛ defined in Equation (12) is K·W·K_{d}^{(k)}. However, if Equation (15) and Equation (19) are used, the number of columns is fixed, simplifying signal processing.

A description will now be made of least square beam forming according to an embodiment of the present invention. A joint transmission paradigm considered in the present invention will be described in detail with mathematical expressions.

The number of data symbols constituting a half burst of a burst transmission frame and the number of OVSF code chips per data symbol will be denoted by N and Q, respectively. If KN data symbols are denoted by a reception data vector d, an NQ×N OVSF matrix representing an OVSF code allocated to a k^{th} user (user #k) is expressed as

$${\underline{C}}^{( k )} = ( \begin{matrix}{\underline{c}}_{1}^{( k )} & 0 & ⋯ & 0 \\ {\underline{c}}_{2}^{( k )} & 0 & ⋯ & 0 \\ ⋮ & ⋮ & ⋮ & ⋮ \\ {\underline{c}}_{Q}^{( k )} & 0 & ⋯ & 0 \\ 0 & {\underline{c}}_{1}^{( k )} & ⋯ & 0 \\ 0 & {\underline{c}}_{2}^{( k )} & ⋯ & 0 \\ ⋮ & ⋮ & ⋯ & ⋮ \\ 0 & {\underline{c}}_{Q}^{( k )} & ⋯ & 0 \\ ⋮ & ⋮ & ⋮ & ⋮ \\ 0 & 0 & ⋯ & {\underline{c}}_{1}^{( k )} \\ 0 & 0 & ⋯ & {\underline{c}}_{2}^{( k )} \\ ⋮ & ⋮ & ⋮ & ⋮ \\ 0 & 0 & ⋯ & {\underline{c}}_{Q}^{( k )}\end{matrix} ) \qquad ( 20 )$$

In Equation (20), c₁^{(k)} . . . c_{Q}^{(k)} denotes Q orthogonal codes. Furthermore, a directional channel impulse response for N_{b} directions of a user #k is defined as

$${\underline{H}}_{d}^{( k )} = ( \begin{matrix}{\underline{H}}_{d}^{( k , 1 )} \\ {\underline{H}}_{d}^{( k , 2 )} \\ ⋮ \\ {\underline{H}}_{d}^{( k , {N}_{b} )}\end{matrix} ) , k = 1 ⋯ K \qquad ( 21 )$$

If W paths are considered, the directional channel impulse response is transformed as shown in Equation (22) below.

$${\underline{H}}_{d}^{( k , {k}_{d} )} = ( \begin{matrix}{\underline{h}}_{d , 1}^{( k , {k}_{d} )} & 0 & ⋯ & 0 \\ {\underline{h}}_{d , 2}^{( k , {k}_{d} )} & {\underline{h}}_{d , 1}^{( k , {k}_{d} )} & ⋯ & 0 \\ ⋮ & ⋮ & ⋯ & ⋮ \\ {\underline{h}}_{d , W}^{( k , {k}_{d} )} & {\underline{h}}_{d , W - 1}^{( k , {k}_{d} )} & ⋯ & 0 \\ 0 & {\underline{h}}_{d , W}^{( k , {k}_{d} )} & ⋯ & 0 \\ 0 & 0 & ⋯ & 0 \\ ⋮ & ⋮ & ⋯ & ⋮ \\ 0 & 0 & ⋯ & {\underline{h}}_{d , 1}^{( k , {k}_{d} )} \\ 0 & 0 & ⋯ & {\underline{h}}_{d , 2}^{( k , {k}_{d} )} \\ ⋮ & ⋮ & ⋯ & ⋮ \\ 0 & 0 & ⋯ & {\underline{h}}_{d , W}^{( k , {k}_{d} )}\end{matrix} ) , k = 1 ⋯ K , {k}_{d} = 1 ⋯ {N}_{b} \qquad ( 22 )$$

where h_{d,w}^{(k,k}^{_{d}}⁾ denotes a directional channel impulse response vector for a w^{th} path for an antenna element kₐ of a user #k.

Considering a spatial phase matrix for a user #k, shown in Equation (23) below, a Kₐ×KN_{b} spatial phase matrix of Equation (25) below is obtained.

$$\begin{matrix}{\underline{B}}_{s}^{( k )} = ( \begin{matrix}{ⅇ}^{{jΨ}^{( k , 1 , 1 )}} & {ⅇ}^{{jΨ}^{( k , 1 , 2 )}} & ⋯ & {ⅇ}^{{jΨ}^{( k , 1 , {k}_{d} )}} & ⋯ & {ⅇ}^{{jΨ}^{( k , 1 , {N}_{b} )}} \\ {ⅇ}^{{jΨ}^{( k , 2 , 1 )}} & {ⅇ}^{{jΨ}^{( k , 2 , 2 )}} & ⋯ & {ⅇ}^{{jΨ}^{( k , 2 , {k}_{d} )}} & ⋯ & {ⅇ}^{{jΨ}^{( k , 2 , {N}_{b} )}} \\ ⋮ & ⋮ & ⋮ & ⋮ & ⋮ & ⋮ \\ {ⅇ}^{{jΨ}^{( k , {k}_{a} , 1 )}} & {ⅇ}^{{jΨ}^{( k , {k}_{a} , 2 )}} & ⋯ & {ⅇ}^{{jΨ}^{( k , {k}_{a} , {k}_{d} )}} & ⋯ & {ⅇ}^{{jΨ}^{( k , {k}_{a} , {N}_{b} )}} \\ ⋮ & ⋮ & ⋮ & ⋮ & ⋮ & ⋮ \\ {ⅇ}^{{jΨ}^{( k , {K}_{a} , 1 )}} & {ⅇ}^{{jΨ}^{( k , {K}_{a} , 2 )}} & ⋯ & {ⅇ}^{{jΨ}^{( k , {K}_{a} , {k}_{d} )}} & ⋯ & {ⅇ}^{{jΨ}^{( k , {K}_{a} , {N}_{b} )}}\end{matrix} ) , k = 1 ⋯ K & ( 23 ) \\ {\underline{B}}_{s} = ( {\underline{B}}_{s}^{( 1 )} , {\underline{B}}_{s}^{( 2 )} , ⋯ , {\underline{B}}_{s}^{( K )} ) & ( 24 )\end{matrix}$$

Using the OVSF code for a user #k shown in Equation (20) and the directional channel impulse response matrix for the user #k shown in Equation (21), the following matrix is calculated.
A_{d}^{(k)}=H_{d}^{(k)}C^{(k)}, k=1 . . . K (25)

Data transmission over a radio channel using the OVSF code can be mathematically expressed by a system matrix given below

$${\underline{H}}_{d}^{( k )} = ( \begin{matrix}{\underline{H}}_{d}^{( k , 1 )} \\ {\underline{H}}_{d}^{( k , 2 )} \\ ⋮ \\ {\underline{H}}_{d}^{( k , {N}_{b} )}\end{matrix} ) , k = 1 ⋯ K \qquad ( 26 )$$

That is, the system matrix A_{d} mathematically indicates that data for each of K users is spread with a corresponding OVSF code and then transmitted through a corresponding channel.

In another case, the data transmission is expressed by a system matrix given below.
A=(Bₛ⊕I_{NQ+W-1})A_{d} (27)
where I_{NQ+W-1} denotes an (NQ+W−1)×(NQ+W−1) identity matrix.

In conclusion, a signal vector e received at the receiver is estimated by a system matrix defined as
e=Ad+n=(Bₛ⊕I_{NQ+W-1})A_{d}d+n (28)
where n denotes a noise vector.

Assuming that a zero forcing block linear equalizer (ZF-BLE), one of the approaches for detecting data symbols from a received signal, is used, noise power including noise and interference from a transmitter to the receiver can be expressed as
Rₙ=[R_{DOA}+N₀I_{K}_{_{α}}]⊕I_{L} (29)
where R_{DOA} denotes noise power of a corresponding DOA, N₀ denotes a spectral noise density, I denotes an identity matrix, and L denotes the possible number of interferences which is incident upon the receiver. Therefore, an estimated data vector is given by
d=[A^{H}Rₙ⁻¹A]⁻¹A^{H}Rₙ⁻¹e (30)
where a superscript ‘H’ denotes Hermitian transform.

When a minimum mean square error-block linear equalizer (MMSE-BLE), an alternative approach for detecting data symbols from a received signal, is used, the estimated data vector is calculated by

$$\hat{\underline{d}} \approx {[ {{\underline{A}}^{H} [ {\underline{R}}_{DOA} + {N}_{0} {I}_{{K}_{a}} ]}^{- 1} ⊗ {\tilde{\underline{R}}}^{- 1} \underline{A} + {\underline{R}}_{d}^{- 1} ]}^{- 1} {{\underline{A}}^{H} [ {\underline{R}}_{DOA} + {N}_{0} {I}_{{K}_{a}} ]}^{- 1} ⊗ {\tilde{\underline{R}}}^{- 1} \underline{e} \qquad ( 31 )$$

where R_{d}⁻¹ denotes an inverse of a covariance matrix representing noise of data symbols.

Regardless of which approach is used, the present invention relates to DOA quantization for both useful and interfering signals. If a receive signal matrix is expressed as Equation (32) below, the ZF-BLE estimated data vector shown in Equation (30) is transformed as shown in Equation (33).

$$\begin{matrix}\underline{E} = ( {\underline{e}}^{( 1 )} , {\underline{e}}^{( 2 )} , ⋯ , {\underline{e}}^{( {K}_{a} )} ) & ( 32 ) \\ \begin{matrix}\hat{\underline{d}} \approx {[ {{\underline{A}}^{H} [ {\underline{R}}_{DOA} + {N}_{0} {I}_{{K}_{a}} ]}^{- 1} ⊗ {\tilde{\underline{R}}}^{- 1} \underline{A} ]}^{- 1} {\underline{A}}_{d}^{H} ( {\underline{B}}_{s}^{H} ⊗ {I}_{NQ + W - 1} ) \\ ( {[ {\underline{R}}_{DOA} + {N}_{0} {I}_{{K}_{a}} ]}^{- 1} ⊗ {\tilde{\underline{R}}}^{- 1} ) \underline{e} \\ = {[ {{\underline{A}}^{H} [ {\underline{R}}_{DOA} + {N}_{0} {I}_{{K}_{a}} ]}^{- 1} ⊗ {\tilde{\underline{R}}}^{- 1} \underline{A} ]}^{- 1} {\underline{A}}_{d}^{H} {{\underline{B}}_{s}^{H} [ {\underline{R}}_{DOA} + {N}_{0} {I}_{{K}_{a}} ]}^{- 1} ⊗ {\tilde{\underline{R}}}^{- 1} \underline{e} \\ = {[ {{\underline{A}}^{H} [ {\underline{R}}_{DOA} + {N}_{0} {I}_{{K}_{a}} ]}^{- 1} ⊗ {\tilde{\underline{R}}}^{- 1} \underline{A} ]}^{- 1} {\underline{A}}_{d}^{H} vec \{ {\tilde{\underline{R}}}^{- 1} \\ {E [ {\underline{R}}_{DOA}^{*} + {N}_{0} {I}_{{K}_{a}} ]}^{- 1} {\underline{B}}_{s}^{*} \} .\end{matrix} & ( 33 )\end{matrix}$$

The typical ZF-BLE approach cannot be applied to a multipath, multiuser scenario. However, it can be noted from Equation (33) that beam forming is achieved by a matrix product [R*_{DOA}+N₀I_{K}_{_{α}}]⁻¹B*ₛ. In addition, a steering vector is given as

$${\underline{b}}_{s}^{( k , {k}_{d} )} = {( {ⅇ}^{{jΨ}^{( k , 1 , {k}_{d} )}} ⋯ {ⅇ}^{{jΨ}^{( k , {K}_{a} , {k}_{d} )}} )}^{T} , k = 1 ⋯ K , {k}_{d} = 1 ⋯ {N}_{b} \qquad ( 34 )$$

Because the steering vector is a basis for a spatial phase matrix Bₛ, a weight vector for beam forming becomes

$${\underline{w}}_{opt}^{( k , {k}_{d} )} = {[ {\underline{R}}_{DOA}^{*} + {N}_{0} {I}_{{K}_{a}} ]}^{- 1} {\underline{b}}_{s}^{{( k , {k}_{d} )}^{*}} , k = 1 ⋯ K , {k}_{d} = 1 ⋯ {N}_{b} \qquad ( 35 )$$

Assuming that predetermined DOA values are used, the optimal weight vector of Equation (35) is computed jointly for each user #k (k=1 . . . K) and for each DOA #k_{d} (k_{d}=1 . . . N_{b}). A discrete-time output of a beam former using the optimal weight vector is given by

$${\underline{y}}^{( k , {k}_{d} )} = \underline{E} \underbrace{{[ {\underline{R}}_{DOA}^{*} + {N}_{0} {I}_{{K}_{a}} ]}^{- 1} {\underline{b}}_{s}^{{( k , {k}_{d} )}^{*}}}_{{{w}_{-}}_{opt}^{( k , {k}_{d} )}} = \underline{E} {\underline{w}}_{opt}^{( k , {k}_{d} )} , k = 1 ⋯ K , {k}_{d} = 1 ⋯ {N}_{b} \qquad ( 36 )$$

Among the discrete-time outputs computed for predetermined DOA values, an output having the highest energy is actually selected for data demodulation.

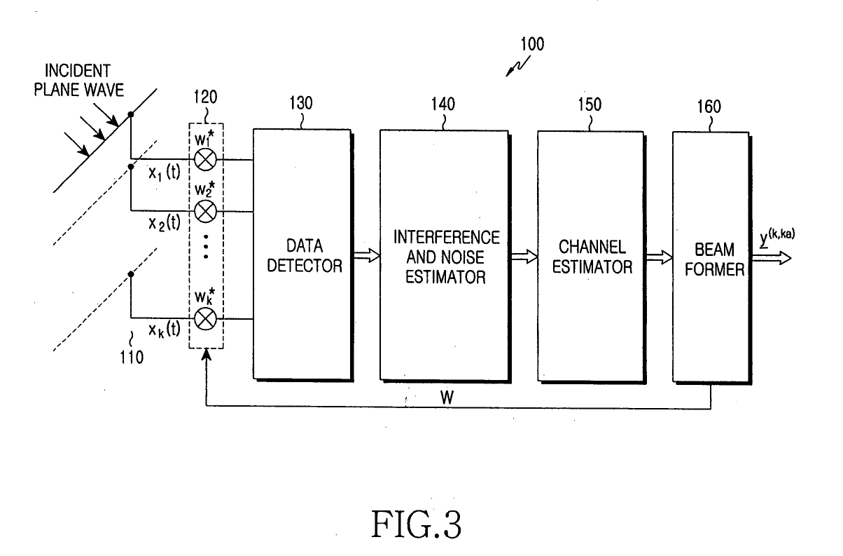

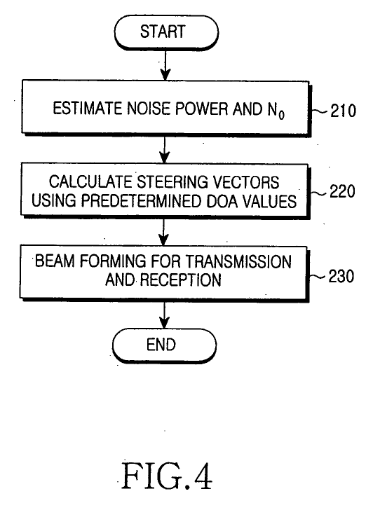

FIG. 3 illustrates a structure of a receiver 100 in an array antenna system according to an embodiment of the present invention, and FIG. 4 is a flowchart illustrating operations of an interference and noise estimator 140, a channel estimator 150 and a beam former 160 in the receiver 100. An embodiment of the present invention will now be described with reference to FIGS. 3 and 4.

Referring to FIG. 3, an antenna 110 is an array antenna having antenna elements in predetermined array geometry, and receives a plurality of spatial signals which are incident thereupon through spaces. By way of example, it is shown in FIG. 3 that an incident plane wave from only one direction is received at each of the antenna elements with a different phase. Each of multipliers 120 multiplies its associated antenna element by a weight for the corresponding antenna element, determined by the beam former 160. A data detector 130 performs frequency down-conversion, demodulation, and channel selection on the outputs of the antenna elements, to which the weights were applied, thereby detecting a digital data signal.

Referring to FIG. 4, in step 210 , the interference and noise estimator 140 estimates interference power RDOA and a spectral noise density N₀ of thermal noise power using data signals provided from the data detector 130.

An example of estimating the spectral noise power density N₀ is as follows:

1. Switch off all reception antennas.

2. Sample the complex baseband nose signal prevailing at each analog reception branch.

3. Determine the variance of the complex baseband noise sequence. The variance is identical to N₀.

Another method is given by measurement of an absolute receiver temperature T. It is found that N₀=Fk_{B}T, where F denotes a linear noise figure being dependent upon a type of antenna, k_{B} denotes Boltzman's constant and T denotes the absolute receiver temperature.

Next, the interference power is estimated in the following method. Assuming that there is no correlation between interference signals, only the diagonal elements are required for estimation of the \hat{R}_{DOA}. Assuming that only the number of DOAs and the interference signals in the same direction are taken into consideration, power (σ^{(k}^{ᵢ}⁾)² of a kᵢ^{th} interference signal can be obviously determined. Therefore, the diagonal elements are simply determined by power of a kᵢ^{th} interference signal as shown in Equation (37).
[R_{DOA}]ₖ_{ᵢ}ₖ_{ᵢ}=(σ^{(k}^{ᵢ}⁾)²+N₀ (37)
where kᵢ denotes a natural number between 1 and Kₐ, and a subscript ‘kᵢ,kᵢ’ denotes a kᵢ^{th} row in a kᵢ^{th} column.

The interference power and the spectral noise density are used in the channel estimator 150 to estimate a directional channel impulse response and a combined channel impulse response, required for estimation of radio channel environment.

In step 220, the beam former 160 jointly calculates steering vectors for each direction k_{d} for each user #k by Equation (34) using N_{b} predetermined DOA values. In step 230, the beam former 160 calculates the weigh vectors of Equation (35) using the calculated steering vectors, and obtains a discrete-time output in which beams are formed for all directions, by multiplying received signals for all directions for each antenna by the weight vectors. As a result, the discrete-time output in the direction having the highest energy is selected.

As can be understood from the foregoing description, the novel beam former performs regular spatial sampling instead of estimating DOAs needed for determining weights, thereby omitting the processes needed for estimating DOAs without considerably deteriorating the beam forming performance. By doing so, the beam forming algorithm is remarkably simplified.

While the invention has been shown and described with reference to a certain embodiments thereof, it will be understood by those skilled in the art that various changes in form and details may be made therein without departing from the spirit and scope of the invention as defined by the appended claims.

1. A beam forming apparatus for an antenna diversity system that services a plurality of users with an array antenna having a plurality of antenna elements, the apparatus comprising:
an interference and noise calculator for estimating interference power and spectral noise density for a radio channel from a transmitter to a receiver; and
a beam former for calculating steering vectors corresponding to a predetermined number of regularly spaced predetermined direction-of-arrival (DOA) values, and calculating weight vectors for beam forming by applying the interference power and the spectral noise density to the steering vectors.

2. The beam forming apparatus of claim 1, wherein the steering vectors are calculated by
$${\underline{b}}_{s}^{( k , {k}_{d} )} = {( {ⅇ}^{jΨ ( k , 1 , {k}_{d} )} … {ⅇ}^{jΨ ( k , {K}_{a} , {k}_{d} )} )}^{T} , k = 1 … K , {k}_{d} = 1 … {N}_{b}$$
$$Ψ ( k , {k}_{a} , {k}_{d} ) = 2 π \frac{{l}^{( {k}_{a} )}}{λ} \cdot cos ( {β}^{( k , {k}_{d} )} - {α}^{( {k}_{a} )} ) , k = 1 … K , {k}_{a} = 1 … {K}_{a} , {k}_{d} = 1 … {K}_{d}^{( k )}$$
where bₛ^{Ik,k}^{_{d}}⁾ denotes a steering vector for a direction k_{d} of a user #k, K denotes the number of user equipments, Kₐ denotes the number of the antenna elements, N_{b} and K_{d}^{(k)} denote the number of the DOA values, Ψ^{(k,k}^{_{α}}^{k}^{_{d}}⁾ denotes a phase factor for a direction k_{d} of an antenna element kₐ for the user #k, λ denotes a wavelength of a carrier frequency, l^{(k}^{_{α}}⁾ denotes a distance between a kₐ^{th} antenna element and an antenna array reference point, β^{(k,k}^{_{d}}⁾ denotes a k_{d}^{th} DOA value predetermined for the user #k, and α^{(k}^{_{α}}⁾ denotes an angle from a reference line of the antenna elements.

3. The beam forming apparatus of claim 1, wherein the weight vectors are calculated by
$${\underline{w}}_{opt}^{( k , {k}_{d} )} = {[ {\underline{R}}_{DOA}^{*} + {N}_{0} {I}_{{K}_{a}} ]}^{- 1} {\underline{b}}_{s}^{{( k , {k}_{d} )}^{*}} , k = 1 … K , {k}_{d} = 1 … {N}_{b}$$
where
$${\underline{w}}_{opt}^{( k , {k}_{d} )}$$
denotes a weight vector for a direction k_{d} of a user #k, R*_{DOA} denotes a conjugate of the interference power, N₀ denotes the spectral noise density, I_{K}_{_{α}} denotes a Kₐ×Kₐ identity matrix, Kₐ denotes the number of the antenna elements, and N_{b} denotes the number of the DOA values.

4. The beam forming apparatus of claim 3, wherein the interference power is expressed with a Hermitian matrix of which diagonal elements are defined in the following equation,
[R_{DOA}]ₖ_{ᵢ}ₖ_{ᵢ}=(σ^{(k}^{ᵢ}⁾)²+N₀
where (σ^{(k}^{ᵢ}⁾)² denotes power of a kᵢ^{th} interference signal, and N₀ denotes the spectral noise density.

5. The beam forming apparatus of claim 1, wherein the beam former calculates discrete-time outputs corresponding to the DOA values for each user by multiplying a receive signal matrix representing a signal received at the receiver from the transmitter by the weigh vectors.

6. The beam forming apparatus of claim 1, wherein the number of DOA values is set to a maximum integer not exceeding a product of a possible maximum spatial bandwidth of the array antenna and a double circle ratio (2π).

7. The beam forming apparatus of claim 6, wherein the number of DOA values is equal to the number of the antenna elements constituting the array antenna when the array antenna has a uniform circular array (UCA) geometry.

8. The beam forming apparatus of claim 6, wherein the DOA values are defined as
$${β}^{( {k}_{d} )} = {β}_{0} + \frac{2 π}{{N}_{b}} ( {k}_{d} - 1 )$$
where β^{(k}^{_{d}}⁾ denotes a DOA value of a k_{d}^{th} signal, β₀ denotes a randomly selected fixed zero-phase angle, N_{b} denotes the number of the DOA values, and k_{d} denotes a direction index which is an integer between 1 and the N_{b}.

9. The beam forming apparatus of claim 8, wherein the β₀ has a value between 0 and π/N_{b} radian.

10. A beam forming method for an antenna diversity system that services a plurality of users with an array antenna having a plurality of antenna elements, the method comprising the steps of:
estimating interference power and spectral noise density for a radio channel from a transmitter to a receiver;
calculating steering vectors corresponding to a predetermined number of regularly spaced predetermined direction-of-arrival (DOA) values; and
calculating weight vectors for beam forming by applying the interference power and the spectral noise density to the steering vectors.

11. The beam forming method of claim 10, wherein the steering vectors are calculated by
$${\underline{b}}_{s}^{( k , {k}_{d} )} = {( {ⅇ}^{jΨ ( k , 1 , {k}_{d} )} … {ⅇ}^{jΨ ( k , {K}_{a} , {k}_{d} )} )}^{T} , k = 1 … K , {k}_{d} = 1 … {N}_{b}$$
$$Ψ ( k , {k}_{a} , {k}_{d} ) = 2 π \frac{{l}^{( {k}_{a} )}}{λ} \cdot cos ( {β}^{( k , {k}_{d} )} - {α}^{( {k}_{a} )} ) , k = 1 … K , {k}_{a} = 1 … {K}_{a} , {k}_{d} = 1 … {K}_{d}^{( k )}$$
where bₛ^{Ik,k}^{_{d}}⁾ denotes a steering vector for a direction k_{d} of a user #k, K denotes the number of user equipments, Kₐ denotes the number of the antenna elements, N_{b} and K_{d}^{(k)} denote the number of the DOA values, Ψ^{(k,k}^{_{α}}^{k}^{_{d}}⁾ denotes a phase factor for a direction k_{d} of an antenna element kₐ for the user #k, λ denotes a wavelength of a carrier frequency, l^{(k}^{_{α}}⁾ denotes a distance between a kₐ^{th} antenna element and an antenna array reference point, β^{(k,k}^{_{d}}⁾ denotes a k_{d}^{th} DOA value predetermined for the user #k, and α^{(k}^{_{α}}⁾ denotes an angle from a reference line of the antenna elements.

12. The beam forming method of claim 10, wherein the weight vectors are calculated by
$${\underline{w}}_{opt}^{( k , {k}_{d} )} = {[ {\underline{R}}_{DOA}^{*} + {N}_{0} {I}_{{K}_{a}} ]}^{- 1} {\underline{b}}_{s}^{{( k , {k}_{d} )}^{*}} , k = 1 … K , {k}_{d} = 1 … {N}_{b}$$
where
$${\underline{w}}_{opt}^{( k , {k}_{d} )}$$
denotes a weight vector for a direction k_{d} of a user #k, R*_{DOA} denotes a conjugate of the interference power, N₀ denotes the spectral noise density, I_{K}_{_{α}} denotes a Kₐ×Kₐ identity matrix, Kₐ denotes the number of the antenna elements, and N_{b} denotes the number of the DOA values.

13. The beam forming method of claim 12, wherein the interference power is expressed with a Hermitian matrix of which diagonal elements are defined in the following equation,
[R_{DOA}]ₖ_{ᵢ}_{,k}_{ᵢ}=(σ^{(k}^{ᵢ}⁾)²+N₀
where (σ^{(k}^{ᵢ}⁾)² denotes power of a kᵢ^{th} interference signal, and N₀ denotes the spectral noise density.

14. The beam forming method of claim 10, further comprising the step of calculating discrete-time outputs corresponding to the DOA values for each user by multiplying a receive signal matrix representing a signal received at the receiver from the transmitter by the weigh vectors.

15. The beam forming method of claim 10, wherein the number of DOA values is set to a maximum integer not exceeding a product of a possible maximum spatial bandwidth of the array antenna and a double circle ratio (2π).

16. The beam forming method of claim 15, wherein the number of DOA values is equal to the number of the antenna elements constituting the array antenna when the array antenna has a uniform circular array (UCA) geometry.

17. The beam forming method of claim 15, wherein the DOA values are defined as
β^{(k}^{_{d}}⁰=β₀+2/N_{b}(k_{d}−1)
where β^{(k}^{_{d}}⁾ denotes a DOA value of a k_{d}^{th} signal, β₀ denotes a randomly selected fixed zero-phase angle, N_{b} denotes the number of the DOA values, and k_{d} denotes a direction index which is an integer between 1 and the N_{b}.

18. The beam forming method of claim 17, wherein the β₀ has a value between 0 and π/N_{b} radian.
